(19) United States
(12) Patent Application Publication
(10) Pub. No.: US 2010/0301202 A1
(43) Pub. Date: Dec. 2, 2010

(54) Tandem TOF Mass Spectrometer With High Resolution Precursor Selection And Multiplexed MS-MS

(75) Inventor: Marvin L. Vestal, Framingham, MA (US)

Correspondence Address: RAUSCHENBACH PATENT LAW GROUP, LLP, P.O. BOX 387, BEDFORD, MA, 01730, US

(73) Assignee: VIRGIN INSTRUMENTS CORPORATION, Sudbury, MA (US)

(21) Appl. No.: 12/475,432

(22) Filed: May 29, 2009

(51) Int. Cl. B01D 59/44; H01J 49/00

(52) U.S. Cl. 250/282; 250/287

(57) ABSTRACT

A tandem TOF mass spectrometer includes a first TOF mass analyzer that generates an ion beam comprising a plurality of ions and that selects a group of precursor ions from the plurality of ions. A pulsed ion accelerator accelerates and refocuses the selected group of precursor ions. An ion fragmentation chamber is positioned to receive the selected group of precursor ions that is refocused by the pulsed ion accelerator. At least some of the selected group of precursor ions is fragmented in the ion fragmentation chamber. A second TOF mass analyzer receives the selected group of precursor ions and ion fragments thereof from the ion fragmentation chamber and separates the ion fragments and then detects a fragment ion mass spectrum.

The section headings used herein are for organizational purposes only and should not to be construed as limiting the subject matter described in the present application in any way.

### Introduction

Many mass spectrometer applications require an accurate determination of the molecular masses and relative intensities of metabolites, peptides, and intact proteins in complex mixtures. Tandem mass spectrometry provides information on the structure and sequence of many biological polymers and allows unknown samples to be accurately identified. Tandem mass spectrometers employ a first mass analyzer to produce, separate and select a precursor ion, and a second mass analyzer to fragment the selected ions and record the fragment mass spectrum from the selected precursor. A wide variety of mass analyzers and combinations thereof for use in tandem mass spectrometry are known in the literature.

An important advantage of TOF Mass Spectrometry (MS) is that essentially all of the ions produced are detected, which is unlike scanning MS instruments. This advantage is lost in conventional MS-MS instruments where each precursor is selected sequentially and all non-selected ions are lost. This limitation can be overcome by selecting multiple precursors following each laser shot and recording fragment spectra from each can partially overcome this loss and dramatically improve speed and sample utilization without requiring the acquisition of raw spectra at a higher rate.

Several approaches to matrix assisted laser desorption/ionization (MALDI)-TOF MS-MS are described in the prior art. All of these approaches are based on the observation that at least a portion of the ions produced in the MALDI ion source may fragment as they travel through a field-free region. Ions may be energized and fragment as the result of excess energy acquired during the initial laser desorption process, or by energetic collisions with neutral molecules in the plume produced by the laser, or by collisions with neutral gas molecules in the field-free drift region. These fragment ions travel through the drift region with approximately the same velocity as the precursor, but their kinetic energy is reduced in proportion to the mass of the neutral fragment that is lost. A timed-ion-selector may be placed in the drift space to transmit a small range of selected ions and to reject all others. In a TOF mass analyzer employing a reflector, the lower energy fragment ions penetrate less deeply into the reflector and arrive at the detector earlier in time than the corresponding precursors. Conventional reflectors focus ions in time over a relatively narrow range of kinetic energies. Thus, only a small mass range of fragments are focused for given potentials applied to the reflector.

In work by Spengler and Kaufmann, the limitation in mass range was overcome by taking a series of spectra at different mirror voltages and piecing them together to produce the complete fragment spectrum. An alternate approach is to use a “curved field reflector” that focuses the ions in time over a broader energy range. The TOF-TOF approach employs a pulsed accelerator to re-accelerate a selected range of precursor ions and their fragments so that the energy spread of the fragments is sufficiently small that the complete spectrum can be adequately focused using a single set of reflector potentials. All of these approaches have been used to successfully produce MS-MS spectra following MALDI ionization, but each suffers from serious limitations that have stalled widespread acceptance. For example, each approach involves relatively low-resolution selection of a single precursor, and generation of the MS-MS spectrum for that precursor, while ions generated from other precursors present in the sample are discarded. Furthermore, the sensitivity, speed, resolution, and mass accuracy for the first two techniques are inadequate for many applications.

### BRIEF DESCRIPTION OF THE DRAWINGS

The present teachings, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the invention. The drawings are not intended to limit the scope of the Applicant's teachings in any way.

FIG. 1 shows a block diagram of a tandem TOF-TOF mass spectrometry with high resolution precursor selection and multiplexed MS-MS according to the present teaching.

FIG. 2 shows a schematic diagram of a tandem TOF-TOF mass spectrometer with high resolution precursor selection and multiplexed MS-MS according to the present teaching.

FIG. 3 is a schematic diagram of a first TOF mass analyzer for producing and selecting precursor ions.

FIG. 4 is a schematic diagram of a second high resolution TOF mass analyzer for fragmenting selected precursor ions and separating fragment ions from each precursor according to the mass-to-charge ratio of the fragments and detecting the mass spectra of the fragment ions.

FIG. 5 shows a potential diagram for a portion of the second time-of-flight analyzer according to one embodiment of the present invention.

FIG. 6 is a schematic representation of one embodiment of a timed ion selector according to the present invention that uses a pair of Bradbury-Nielsen type ion shutters or gates.

FIG. 7 illustrates typical voltage waveforms that are applied to the Bradbury-Nielsen timed ion selector in a TOF-TOF mass spectrometer with high resolution precursor selection and multiplexed MS-MS operation according to the present teaching.

FIG. 8 presents a graph of calculated deflection distances for the Bradbury-Nielsen timed ion selector in a mass spectrometer according to the present invention that is capable of high resolution precursor selection.

### DESCRIPTION OF VARIOUS EMBODIMENTS

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

It should be understood that the individual steps of the methods of the present teachings may be performed in any order and/or simultaneously as long as the invention remains operable. Furthermore, it should be understood that the apparatus and methods of the present teachings can include any number or all of the described embodiments as long as the invention remains operable.

The present teachings will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teachings herein will recognize additional implementations, modifications, and embodiments, as well as other fields of use, which are within the scope of the present disclosure as described herein.

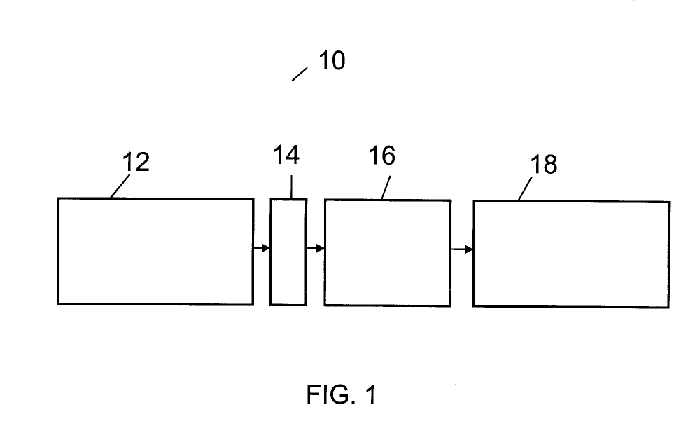

FIG. 1 shows a block diagram of a tandem TOF mass spectrometer 10 with high resolution precursor selection and multiplexed MS-MS according to the present teaching. The tandem TOF mass spectrometer 10 includes a first high resolution TOF mass analyzer 12 for separating precursor ions according to their mass-to-charge ratio including a timed ion selector for selecting precursor ions separated, and a first pulsed accelerator 14 that reduces the velocity spread of selected ions. An ion fragmentation chamber 16 fragments the selected precursor ions. A second high resolution TOF mass analyzer 18 separates fragment ions from each selected precursor ions according to the mass-to-charge ratio of the fragments and detects and records the mass spectra of the fragment ions. A unique feature of the tandem TOF mass spectrometer 10 is that mass resolving power and sensitivity of both the first 12 and the second 18 high resolution mass analyzers can be simultaneously optimized.

In one embodiment, an ion detector is mounted adjacent to the timed ion selector on a moveable mount that allows the first high resolution TOF mass analyzer 12 to be operated as a high resolution TOF mass spectrometer for recording the spectrum of ions generated in the ion source. This spectrum includes accurate measurements of the flight times for all ions detected in the spectrum and allows very accurate calibration of the time delays employed in selecting predetermined precursor ions.

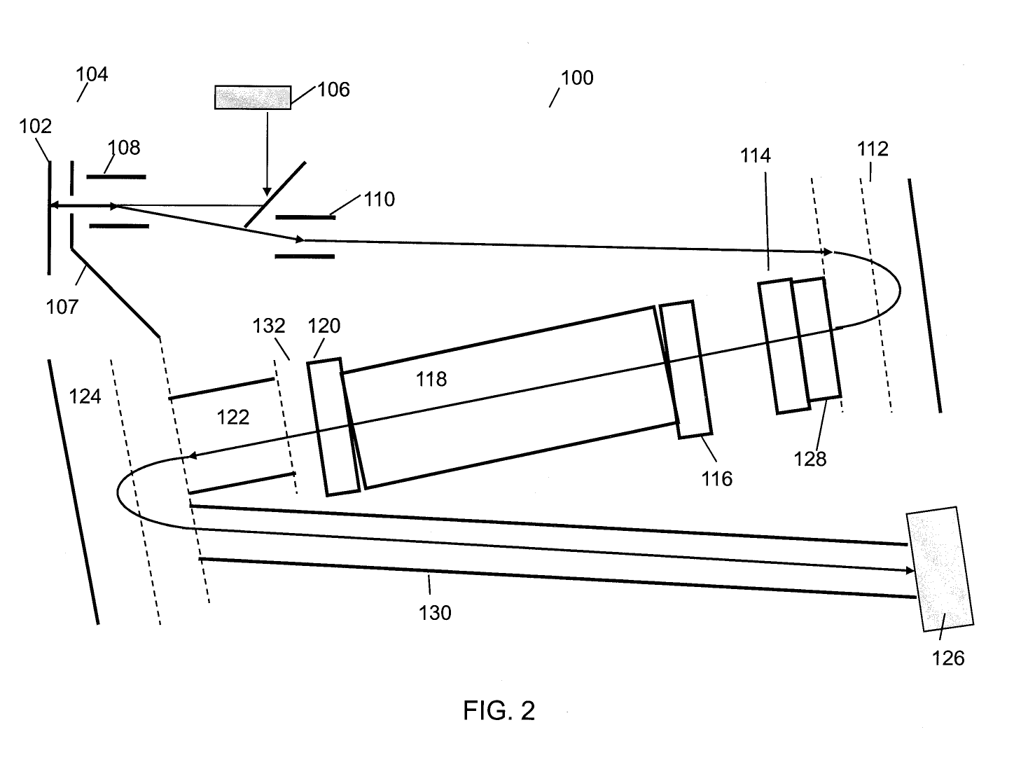

FIG. 2 shows a schematic diagram of a tandem TOF mass spectrometer 100 with high resolution precursor selection and multiplexed MS-MS according to the present teaching. The mass spectrometer 100 includes a sample plate 102 that is installed on a precision x-y translation table which allows a laser beam to raster over the sample plate 102 at any speed up to about 20 mm/sec. The source vacuum housing (not shown) containing the mass spectrometer 100 includes a means for quickly changing the sample plate 102 without venting the system.

The mass spectrometer 100 includes a laser desorption pulsed ion source 104. In one embodiment, the pulsed ion source 104 comprises a two-field pulsed ion source. The pulsed ion source 104 includes a laser 106 that irradiates a sample positioned on the sample plate 102 to generate ions. For example, one suitable laser 106 is a frequency tripled Nd:YLF laser operating at 5 kHz. In some embodiments, the pulsed ion source 104 comprises a matrix-assisted laser desorption/ionization (MALDI) pulsed ion source. However, it should be understood that non-MALDI pulsed ion sources can be used with the mass spectrometer of the present invention.

Ion source optics are positioned after the ion source 104. The ion source optics are designed for high-resolution mass spectra measurements. An extraction electrode 107 is positioned adjacent to the sample plate 102. A first 108 and second ion deflector 110 are positioned after the pulsed ion source 104 in the path of the ion beam. The first and second ion deflectors 108, 110 deflect the ion beam to a first two-stage mirror 112 that is positioned in the path of the ion beam.

In some embodiments, the first and second ion deflectors 108, 110 deflect the ion beam at a predetermined angle that reduces ion trajectory errors that limit the resolving power of the mass spectrometer. In some embodiments, the second ion deflector 110 deflects the ions at a relatively wide angle compared with known time-of-flight mass spectrometers. In some embodiments, X-Y ion beam steering electrodes 128 are positioned near the output of the first ion mirror 112. The X-Y ion beam steering electrodes 128 can be used to correct for minor misalignments of the components in the mass analyzer section of the mass spectrometer 100.

A timed ion selector 114 is positioned in the field-free space after the output of the first ion mirror 112. In one embodiment, the timed ion selector 114 is a Bradbury-Nielsen type ion shutter or gate. A Bradbury-Nielsen type ion shutter or gate is an electrically activated ion gate. Bradbury-Nielsen timed ion selectors include parallel wires that are positioned orthogonal to the path of the ion beam. High-frequency voltage waveforms of opposite polarity are applied to alternate wires in the gate. The gates only pass charged particles at certain times in the waveform cycle when the voltage difference between wires is near zero. At other times, the ion beam is deflected to some angle by the potential difference established between the neighboring wires. The wires are oriented so that ions rejected by the timed ion selector 114 are deflected away from the exit aperture.

The first ion mirror 112 focuses the ion beam at the timed ion selector 114. The timed ion selector 114 passes a desired mass-to-charge ratio range of precursor ions and rejects other ions in the ion beam. The ions passed by the timed ion selector 114 enter into a first pulsed ion accelerator 116 where selected ions are accelerated and their velocity distribution is substantially altered. An ion fragmentation chamber 118 is positioned proximate to the output of the first ion accelerator 116. One skilled in the art will appreciate that any type of fragmentation chamber can be used. In one embodiment, the fragmentation chamber 118 is a collision cell containing a collision gas and an RF-excited octopole that guides fragment ions. The ion fragmentation chamber 118 fragments some of the precursor ions. Precursor ions and fragments thereof then exit the fragmentation chamber 118. A differential vacuum pumping system can be included that prevents excess collision gas from significantly increasing pressure in the tandem TOF mass spectrometer.

A second pulsed ion accelerator 120 is positioned at the output of the ion fragmentation chamber 118. In one embodiment the second pulsed ion accelerator 120 further accelerates the ions and fragments thereof using a static electric field in region 132.

A second ion mirror 124 is positioned after the pulsed ion accelerator 120 and the first electric field-free region 122. An ion detector 126 is positioned after the second ion mirror 124 in a second electric field-free region 130. The second ion mirror 124 is positioned such that ions reflected by the second ion mirror 124 are focused at an ion detector 126. In one embodiment, the ion detector 126 is a discrete dynode electron multipliers, such as the MagneTOF detector, which is a sub-nanosecond ion detector with high dynamic range. The MagneTOF detector is commercially available from ETP Electron Multipliers. The ion detector 126 can be coupled to a transient digitizer, which can perform signal averaging.

It should be understood by those skilled in the art that the schematic diagram shown in FIG. 1 is only a schematic representation and that various additional elements would be necessary to complete a functional mass spectrometer. For example, power supplies are required to power the pulsed ion source 104, the deflectors 108, 110, the timed ion selector 114, the first and second ion mirrors 112, 124, the pulsed accelerator 120, and the detector 126. In addition, a vacuum pumping arrangement is required to maintain the operating pressures in the vacuum chamber housing of the mass spectrometer 100 at the desired operating levels.

The mass spectrometer 100 provides high mass resolving power for precursor selection and for both MS and MS-MS spectra. In various embodiments, the mass spectrometer 100 can be configured for either positive or negative ions, and can be readily switched from one type of ion to the other type of ions.

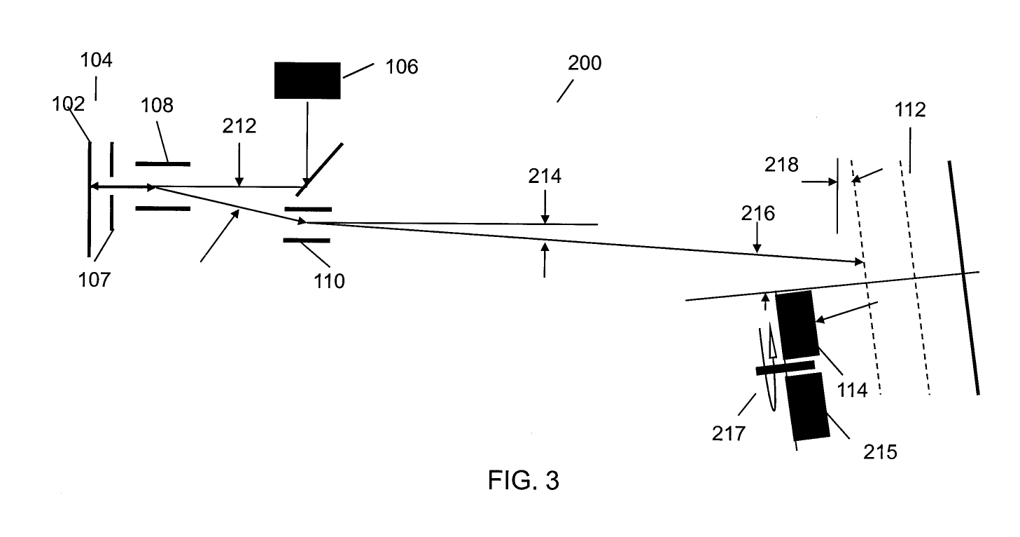

FIG. 3 is a schematic diagram of a first high resolution TOF mass analyzer 200 for separating precursor ions according to their mass-to-charge ratio, and focusing these precursor ions in time at a timed ion selector 114. The laser 106 in the pulsed ion source 104 generates a pulsed laser beam that is directed onto the sample plate 102 in an approximately normal direction. The desorption rate of the laser 106 is the rate that molecules are desorbed per laser pulse and is dependent on the laser pulse parameters. In many embodiments, the overall efficiency of the mass spectrometer is primarily determined by the degree of ionization of desorbed sample.

The characteristics of the pulsed laser beam are important because they determine the required geometry of the mass spectrometer for the desired performance. Higher resolving power in the mass spectrometer 100 can be achieved by keeping the pulsed ion source 104 and the focal lengths of the ion optics as short as practically possible. However, minimizing the focal lengths can increase the relative velocity spread after the first-order focus and, therefore, can seriously degrade the performance of subsequent mass spectrometer stages.

The ions generated by the pulsed ion source 104 exit along the axis of the laser beam. An accelerating voltage is applied to the sample plate 102 that accelerates the ions through an aperture in the extraction electrode 107 so that the ions enter the first stage of the mass spectrometer 100 where they are directed to the first ion mirror 112. A first 108 and second ion deflector 110 are positioned after the pulsed ion source 104 in the path of the ion beam. The first ion deflector 108 deflects the ion beam through an angle 212 and the second ion deflector 110 deflects the ion beam to a final angle 214 relative to the initial direction from the ion source. The ions are then directed to a first two-stage mirror 112 that is positioned in the path of the ion beam and the entrance of the mirror is inclined at an angle 218 relative to a normal to the initial direction of the ion beam.

In some embodiments, the angles 214 and 218 are substantially equal in magnitude, which results in a significant reduction in ion trajectory errors, which limits the resolving power of the mass spectrometer. In some embodiments, the first ion deflector 108 deflects the ions at a relatively wide angle compared with known time-of-flight mass spectrometers. In one specific embodiment, the angle 212 is equal to 4.6 degrees and angles 214 and 218 are each equal to 3 degrees. In this embodiment, the angle 216 between the beam entrance into the mirror and the normal to the mirror is 6 degrees and the angle between the reflected beam and the normal to the mirror is also 6 degrees.

The first ion mirror 112 generates one or more homogeneous, retarding, electrostatic fields that compensates for the effects of the initial kinetic energy distribution of the ions. As the ions penetrate the first ion mirror 112, with respect to the electrostatic fields, they are decelerated until the velocity component of the ions in the direction of the electric field becomes zero. Then, the ions reverse direction and are accelerated back through the ion mirror 112. The ions exit the first ion mirror 112 with energies that are identical to their incoming energy, but with velocities that are in the opposite direction. Ions with larger energies penetrate the ion mirror 112 more deeply and, consequently, will remain in the ion mirror 112 for a longer time. In a properly designed ion mirror, the potentials are selected to modify the flight paths of the ions such that the travel time between the focal points of the ion mirror for ions of like mass and charge is independent of their initial energy.

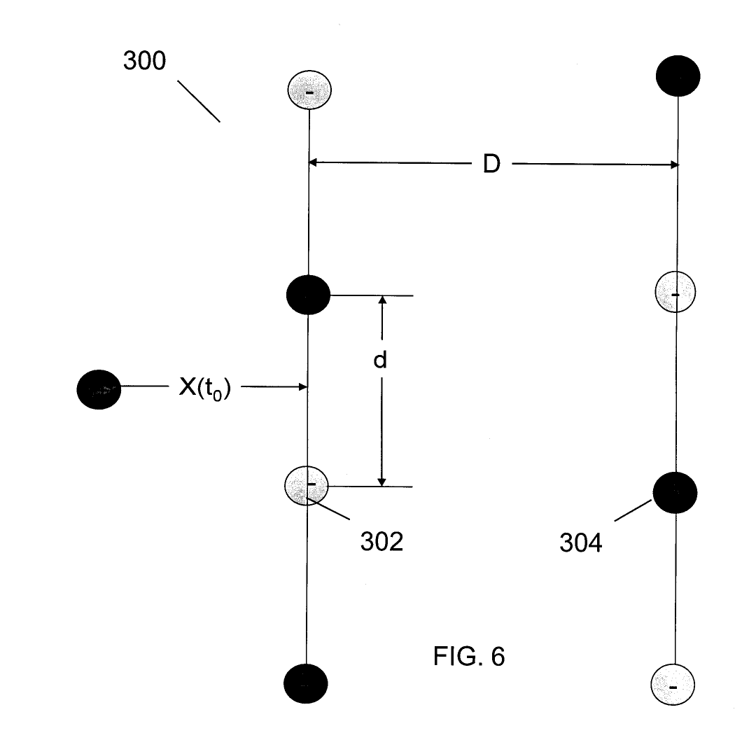

The first ion mirror 112 directs the ion beam to the timed ion selector 114 that is located in the electric field-free space after the first ion mirror 112. A pulsed voltage is applied to the timed ion selector 114 that causes the timed ion selector 114 to pass a portion of the ions in the ion beam and to rejects other ions in the ion beam. The operation of the timed ion selector 114 is described in more detail in connection with FIGS. 6, 7 and 8.

In one embodiment, the timed ion selector 114 is mounted on a moveable mount 217 with an ion detector 215 mounted in an adjacent position. A mechanism is provided that allows either the timed ion selector 114 or the ion detector to be placed in the path of the ion beam exiting first mirror 112 with the system under vacuum and in operation. Locating the ion detector 215 in the path of the ion beam allows the first high resolution TOF mass analyzer 12 (FIG. 1) to be operated as a high resolution TOF mass spectrometer for recording the spectrum of ions generated. This spectrum includes accurate measurements of the flight times for all ions detected in the spectrum and allows very accurate calibration of the time delays employed in selecting predetermined precursor ions. This feature allows high resolution MS spectra to be recorded under precisely identical conditions to those used for generating and separating precursor ions for MS-MS measurements.

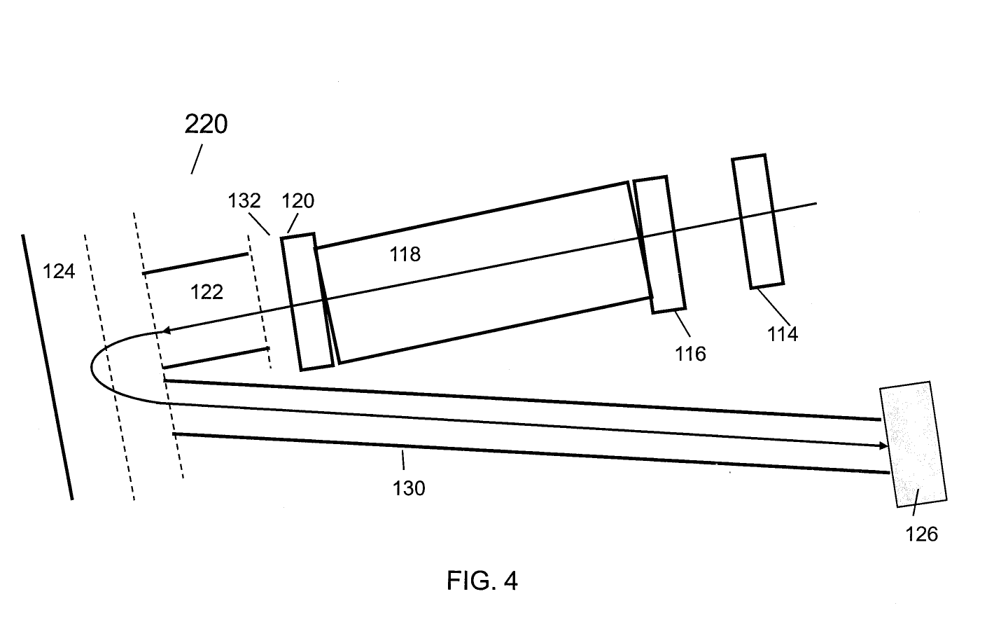

FIG. 4 is a schematic diagram of a second high resolution TOF mass analyzer 220 for fragmenting selected precursor ions and separating fragment ions from each precursor according to the mass-to-charge ratio of the fragments and detecting the mass spectra of the fragment ions. The ions passed by the timed ion selector 114 enter into a first pulsed ion accelerator 116 where selected ions are accelerated and their velocity distribution is substantially altered.

After acceleration in the first pulsed accelerator 116, selected ions enter into the fragmentation chamber 118 where some of the precursor ions are fragmented. Ions exiting from the fragmentation chamber 118 are accelerated by the pulsed ion accelerator 120. This acceleration separates fragment ions from precursors and allows fragment ion masses to be accurately determined from time-of-flight spectra.

The precursor ions and fragments thereof are directed to the second ion mirror 124. The second ion mirror 124 generates one or more homogeneous, retarding, electrostatic fields that further compensates for the effects of the initial kinetic energy distribution of the ions. The selected ions are then reflected by the second ion mirror 124 and travel through a field-free region to the ion detector 126.

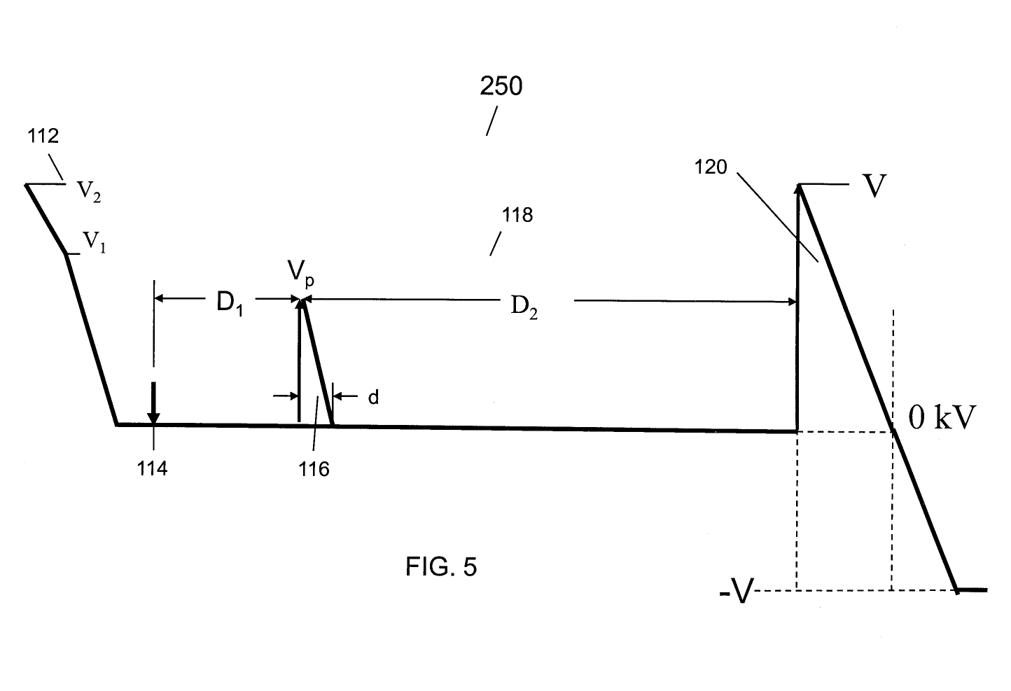

FIG. 5 shows a potential diagram 250 for a portion of the second time-of-flight mass analyzer according to one embodiment of the present invention. Referring to the second high resolution TOF mass analyzer shown in FIG. 4 and the potential diagram 250 shown in FIG. 5, when an ion selected by the timed ion selector 114 substantially reaches the center of the first pulsed accelerator 116, an accelerating voltage pulse Vₚ is applied to the ion accelerator 116. If the ratio of the amplitude of the accelerating pulse Vₚ relative to the energy V₀ of ions exiting the mirror is equal to 4d/D₁, where d is the length of the first pulsed accelerator 116, and D₁ is the distance from the timed ion selector 114 to the center of the first pulsed accelerator 116, then the velocity spread of the ions exiting the ion accelerator 116 is substantially reduced to zero and the velocity focus approaches infinity.

At a higher pulse amplitude Vₚ, the velocity distribution is inverted and the velocity focus may be made to occur at any required distance. At lower pulse amplitudes, the velocity distribution is broadened. After focusing with the first pulsed accelerator, the velocity distribution is reduced by the factor (D₂/D₁)(1+4d/D₁)^{1/2} where D₂ is the distance from the center of the first pulsed accelerator 116 to the entrance to the second pulsed accelerator 120. In one embodiment, the distance D₂ from the first pulsed accelerator 116 to the second pulsed accelerator 120 is more than 10 times the distance D₁ from the timed ion selector 114 to the first pulsed accelerator 116. Thus, a relatively broad velocity distribution at the exit from the first TOF mass analyzer can be effectively removed allowing high performance operation in both analyzers.

FIG. 6 is a schematic representation of one embodiment of a timed ion selector 300 according to the present invention that uses a pair of Bradbury-Nielsen type ion shutters or gates. A Bradbury-Nielsen type ion shutter or gate is an electrically activated ion gate. Bradbury-Nielsen timed ion selectors include parallel wires that are positioned orthogonal to the path of the ion beam. High-frequency voltage waveforms of opposite polarity are applied to alternate wires in the gate. The gates only pass charged particles at certain times in the waveform cycle when the voltage difference between wires is near zero. At other times, the ion beam is deflected to some angle by the potential difference established between the neighboring wires. The wires are oriented so that ions rejected by the timed ion selectors are deflected away from the exit aperture.

The deflection of ions is proportional to the distance of the ions from the plane of the entrance aperture at the time the polarity switches. The mass resolving power can be adjusted by varying the amplitude of the voltage applied to the wires and is only weakly affected by the speed of the transition. In one embodiment where precise measurements are required, a power supply provides the wires of the Bradbury-Nielsen ion selector with an amplitude of approximately ±500 volts with a 7 nsec switching time.

In the embodiment depicted in FIG. 6, the timed ion selector 300 comprises two Bradbury-Nielson gates separated by a small distance D. The Bradbury-Nielson gates are formed from wires with a radius R separated by a distance d. In one specific embodiment, d=1 mm, R=0.025 mm, and D=6 mm. The Bradbury-Nielson gates are closed so that ions are rejected when equal and opposite polarity voltages are applied to adjacent wires in the Bradbury-Nielson gate. The two Bradbury-Nielson gates are accurately aligned so that negatively charged wires 302 in the first gate are accurately aligned with positively charged wires 304 in the second gate.

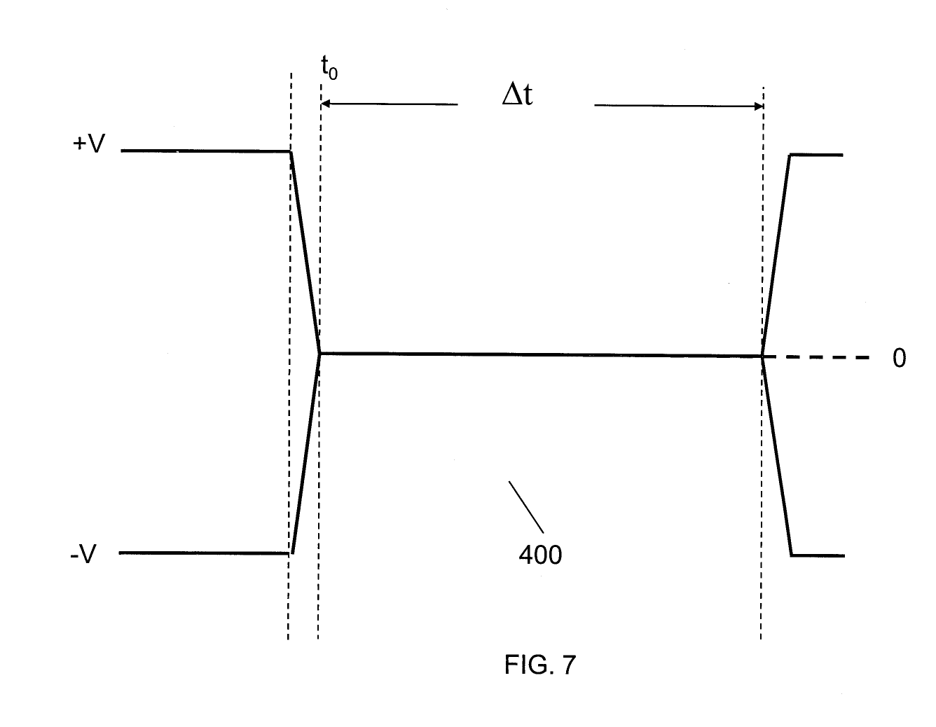

FIG. 7 illustrates typical voltage waveforms 400 that are applied to the Bradbury-Nielsen timed ion selector in a TOF-TOF mass spectrometer with high resolution precursor selection and multiplexed MS-MS operation according to the present teaching. According to one embodiment of the present teaching, separate power supplies are used to provide the waveforms 400 for each gate. Normally one of the gates is closed and the other gate is open as a precursor ion approaches for selection. If the first gate is closed and the second gate open as a predetermined selected mass ion approaches the gate, then the first gate is opened shortly before the ion arrives at the plane of the first gate and the second gate is closed shortly after the ion passes the plane of the second gate. In this way, lower mass ions are rejected by the first gate and high mass ions are rejected by the second gate. The Bradbury-Nielsen gates remain in this state with the first gate open and the second gate closed until the next higher predetermined mass approaches the first gate.

Shortly after the selected ion passes the plane of the first gate, the first gate is closed and the second gate is opened shortly before the selected ion reaches the second gate. In this way, lower mass ions are rejected by the second gate and higher mass ions are rejected by the first gate. Multiple mass peaks can be selected provided the arrival times differ by at least the time required for an ion to travel from the plane of the first gate to the plane of the second gate.

The equations for calculating the performance of a Bradbury-Nielsen type timed ion selector are known. Deflection angle can be determined from the following equation assuming that the voltage is turned on when the ion is at position x₀ and then turned off when the ion is at position x₁ relative to the plane of the gate:

tan α(x₀, x₁)=k(Vₚ/V₀)[(2/π)tan⁻¹({exp((πx₁/dₑ)}−(2/π)tan⁻¹ {exp(πx₀/dₑ)}]

where k is a deflection constant given by k=π {2 ln [cot(πR/2d)]}⁻¹, Vₚ is the deflection voltage (+Vₚ on one wire set, −Vₚ on the other), V₀ is the accelerating voltage of the ions, and dₑ is the effective wire spacing given by dₑ=d cos [(π(d−2R)/4d], where d is the distance between wires and R is the radius of the wire. The angles are expressed in radians.

Ions approaching the Bradbury-Nielsen type timed ion selectors are traveling in the negative x direction and ions leaving the Bradbury-Nielsen type timed ion selectors are traveling in the positive x direction. For continuous application of the deflection voltage, x₀ goes to negative infinity, and x₁ goes to positive infinity. Thus, for a continuous deflection voltage, the deflection angle can be expressed by the following equation:

tan αₘₐₓ=k(Vₚ/V₀).

The deflection voltage is initially on and is turned off when an ion of interest is at distance x₁ from the plane of entrance aperture. The deflection angle is given by the following equation:

tan α=k(Vₚ/V₀))[(4/π)tan⁻¹({exp((πx₁/dₑ)}].

When the deflection voltage is turned on with the ion at position x₂, the deflection angle is given by the following equation:

tan α=k(Vₚ/V₀))[1−(2/π)tan⁻¹ ({exp((πx₂/dₑ)}].

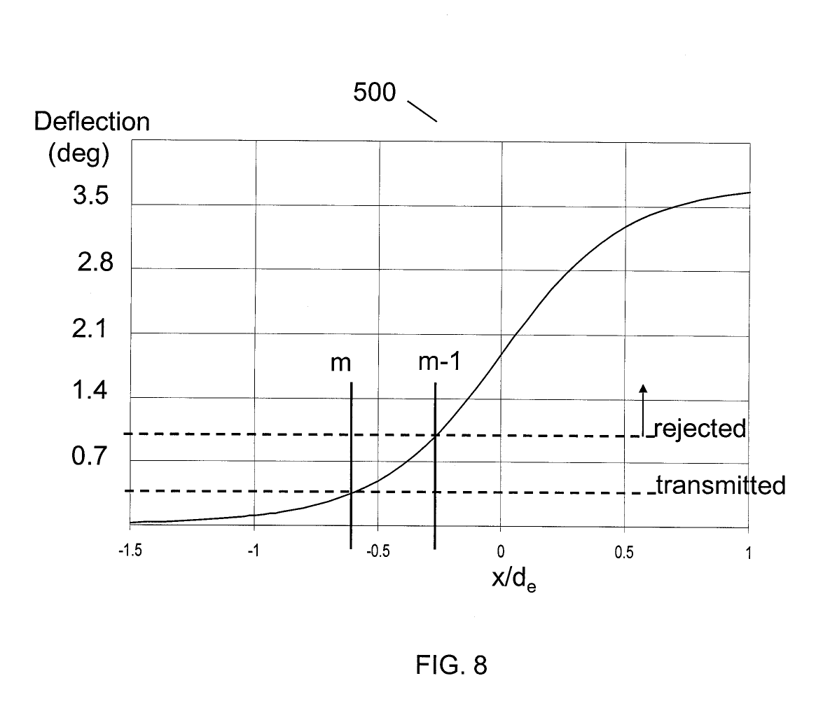

FIG. 8 presents a graph 500 of calculated deflection distances for the Bradbury-Nielsen timed ion selector in a mass spectrometer according to the present invention that is capable of high resolution precursor selection. The deflection distances were calculated using the above equations for a mass-to-charge ratio equal to 4000. The calculations were performed for the parameters d=1 mm, R=0.025 mm, V₀=4 kV, m=4000 Da, k=0.49, d_{eff}/d=0.734, Vₚ=500 volts, and Dₑ=2000 mm.

The deflection distances are average deflection distances in one direction. There is a corresponding second beam deflected by a similar amount in the opposite direction. The deflection distance also depends on the trajectory of the incoming ion relative to the wires in the ion selector. It is known that the total variation in deflection distance due to the initial y position is about ±10% of the average deflection difference.

FIG. 8 illustrates calculated deflection as a function of mass (m/z) of the selected precursor. In this calculation, m corresponds to 4000 Da, and if the gate is opened when this ion is at relative distance x/dₑ=0.6, then it is deflected through an angle of approximately 0.3 degrees. Lower mass ions are deflected through large angles. For example, m−1 (3999 Da) is located at x/dₑ=0.25 and is deflected by about 1 degree. Lower mass ions are deflected through angles up to the maximum of about 3.5 degrees as illustrated in FIG. 8. Higher mass ions are undeflected by the first gate.

The second gate is closed when the selected ion is at a relative distance x/dₑ=0.6 past the gate deflecting the ion approximately 0.3 degrees in the opposite direction from the deflection by the first gate. Thus, the trajectory of the selected ion is at most very slightly perturbed by the ion selector. The lower mass ion (m−1) is at a relative distance x/dₑ=0.95 past the plane of the gate when it is closed and its final trajectory is almost unaffected by the second gate. One the other hand, a higher mass ion (m+1) which was undeflected by the first gate is deflected by about 1 degree by the second gate.

Thus, tandem TOF mass spectrometers according to the present invention include a MALDI ion source, a first TOF mass analyzer for separating precursor ions, a timed ion selector for selecting predetermined precursor ions, a first pulsed ion accelerator for reducing the velocity spread of selected ions, an ion fragmentor, and second TOF mass analyzer for determining the mass-to-charge ratio spectrum of the fragment ions. The dual Bradbury-Nielson gate provides the performance needed for high resolution selection of a large number of precursor ions for multiplex operation of the tandem TOF mass spectrometer.

One aspect of the present teaching is the design of a tandem TOF mass spectrometer where the ion source 104 conditions are adjusted to optimize the performance of the first TOF mass analyzer 12 (FIG. 1). The first TOF mass analyzer 12 is designed so that the first ion mirror 112 refocuses the ion beam from the source focus Dᵥ to the timed ion selector 114 without increasing the other contributions to peak width. The first pulsed accelerator 116 refocuses the selected ions to the second pulsed accelerator 120 without increasing other contributions to peak width so that optimal performance of the second TOF mass analyzer 18 (FIG. 1) for separating and analyzing fragment ions can be obtained simultaneously with optimal performance of the first mass analyzer for selecting precursor ions.

### Equivalents

While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art, which may be made therein without departing from the spirit and scope of the teaching.

What is claimed is:

1. A tandem TOF mass spectrometer comprising:
a) a first TOF mass analyzer that generates an ion beam comprising a plurality of ions and that selects a group of precursor ions from the plurality of ions;
b) a pulsed ion accelerator positioned to receive the selected group of precursor ions, the pulsed ion accelerator accelerating and refocusing the selected group of precursor ions;
c) an ion fragmentation chamber positioned to receive the selected group of precursor ions that is accelerated and refocused by the pulsed ion accelerator, at least some of the selected group of precursor ions being fragmented in the ion fragmentation chamber; and
d) a second TOF mass analyzer that receives the selected group of precursor ions and ion fragments thereof from the ion fragmentation chamber, the second TOF mass analyzer separating the ion fragments and detecting a fragment ion mass spectrum.

2. The tandem TOF mass spectrometer of claim 1 wherein the first TOF mass analyzer comprises:
a) a pulsed ion source that generates a pulse of ions from a sample to be analyzed;
b) an ion lens positioned in a path of the pulse of ions, the ion lens focusing the pulse of ions into an ion beam;
c) an ion deflector positioned in a path of the ion beam, the ion deflector deflecting the ion beam into a deflected ion beam path;
d) an ion mirror that is positioned in the deflected ion beam path so that a plane of constant ion flight time is parallel to an input surface of the ion mirror, the ion mirror generating a reflected ion beam; and
e) a timed ion selector that is positioned in a path of the reflected ion beam, wherein an input surface of the timed ion selector is substantially parallel to an exit plane of the ion mirror, the timed ion selector selecting precursor ions with time-of-flights from the pulsed ion source to the timed ion selector that are substantially independent of a path traveled.

3. The tandem TOF mass spectrometer of claim 2 wherein the second time-of-flight mass analyzer further comprises:
a) a second pulsed ion accelerator that is positioned to receive the selected precursor ions and fragments thereof from the fragmentation chamber, the second pulsed ion accelerator accelerating the selected precursor ions and fragments thereof,
b) a second ion mirror that is positioned in a path of the selected precursor ions and fragments thereof accelerated by the second pulsed ion accelerator, the second ion mirror generating a reflected ion beam comprising the selected precursor ions and fragments thereof; and
c) an ion detector positioned in a path of the reflected ion beam generated by the second ion mirror, the ion detector detecting selected precursor ions and fragments thereof, wherein a flight time from the second pulsed ion accelerator to the ion detector is dependent on a mass-to-charge ratio of the selected precursor ions and fragments thereof and is nearly independent of a velocity distribution of the selected precursor ions and fragments thereof.

4. The tandem TOF mass spectrometer of claim 3 wherein the second time-of-flight mass analyzer further comprises:
a) a second timed ion selector positioned in a path of the selected precursor ions and fragments thereof accelerated by the second pulsed ion accelerator, the second timed ion selector selecting a predetermined portion of the fragment ions from each precursor; and
b) a field-free drift space positioned between the second time ion selector and the ion detector, the field free drift space being biased with a static accelerating field that accelerates the fragment ions from each precursor ion, wherein the ion detector comprises an input surface that is biased at substantially the same potential as the field-free drift space.

5. The tandem TOF mass spectrometer of claim 4 wherein entrance planes of at least two of the ion mirror, the second ion mirror, the timed ion selector, the second timed ion selector, the ion accelerator, the second ion selector, and the ion detector are substantially parallel.

6. The tandem TOF mass spectrometer of claim 2 wherein the pulsed ion source comprises a MALDI pulsed ion source.

7. The tandem TOF mass spectrometer of claim 2 wherein the timed ion selector comprises a pair of Bradbury-Nielson ion gates configured to provide high resolution selection of precursor ions with minimal perturbations of transmitted ions.

8. The tandem TOF mass spectrometer of claim 2 wherein the first TOF mass analyzer further comprises an ion detector mounted adjacent to the timed ion selector on a moveable stage that can be controlled without venting the tandem TOF mass spectrometer.

9. The tandem TOF mass spectrometer of claim 3 wherein at least one of the first and the second ion mirror comprises a two-stage ion reflector.

10. The tandem TOF mass spectrometer of claim 2 wherein an entrance plane of the ion mirror is inclined at a predetermined angle relative to a direction of ion extraction from the pulsed ion source that reduces ion trajectory errors which limit mass resolving power.

11. The tandem TOF mass spectrometer of claim 1 wherein the fragmentation chamber comprises a collision cell with an RF-excited octopole that guides the fragment ions.

12. The tandem TOF mass spectrometer of claim 1 wherein the ion fragmentation chamber comprises a differential vacuum pumping system that prevent excess collision gas from significantly increasing pressure in the tandem TOF mass spectrometer.

13. The tandem TOF mass spectrometer of claim 2 further comprising an ion deflector positioned proximate an output of the pulsed ion source, the ion deflector deflecting the ion beam generated by the pulsed ion source at a predetermined angle that reduces ion trajectory errors that limit mass resolving power.

14. The tandem TOF mass spectrometer of claim 13 wherein the predetermined angle that the ion deflector deflects the ion beam generated by the pulsed ion source is substantially equal to a predetermined angle that the input to the ion mirror is tilted relative to the direction of the ion beam.

15. A method of measuring mass-to-charge ratio, the method comprising:
a) performing a first TOF mass analysis by generating an ion beam comprising a plurality of ions and then selecting a group of precursor ions from the plurality of ions;
b) accelerating the selected group of precursor ions;
c) fragmenting at least some of the selected group of precursor ions; and
d) performing a second TOF mass analysis by separating the ion fragments and detecting a fragment ion mass spectrum.

16. The method of claim 15 wherein the generating the ion beam comprising generating an ion beam from a MALDI pulsed ion source.

17. The method of claim 15 wherein the performing the first TOF mass analysis further comprises focusing the pulse of ions into an ion beam.

18. The method of claim 15 wherein the performing the first TOF mass analysis further comprises generating a reflected ion beam with an ion mirror.

19. The method of claim 15 wherein the selecting the group of precursor ions from the plurality of ions comprises selecting precursor ions with time-of-flights that are substantially independent of a path traveled.

20. The method of claim 15 wherein the performing the first TOF mass analysis and the performing a second TOF mass analysis are independently optimized.

21. The method of claim 15 wherein the accelerating the selected group of precursor ions further comprises focusing the selected group of precursor ions.

22. The method of claim 15 further comprising accelerating the selected precursor ions and fragments thereof.

23. The method of claim 22 further comprising reflecting the accelerated selected precursor ions and fragments thereof.

24. The method of claim 23 wherein a flight time of the accelerated selected precursor ions and fragments thereof is dependent on a mass-to-charge ratio of the precursor ions and fragments thereof and is nearly independent of a velocity distribution of the selected ions.

25. The method of claim 15 further comprising selecting a predetermined portion of the fragment ions from each precursor.

26. The method of claim 15 further comprising biasing an electric field-free drift space with a static accelerating electric field that accelerates the fragment ions from each precursor.

27. The method of claim 15 wherein the fragmenting at least some of the selected group of precursor ions comprises differential vacuum pumping to prevent excess collision gas from significantly increasing pressure.

28. The method of claim 15 further comprising deflecting the ion beam at a predetermined angle that reduces ion trajectory errors which limit mass resolving power.

29. The method of claim 15 further comprising orienting the ion beam to minimize the first order focusing errors for fragment ions.

30. The method of claim 15 wherein a flight time of the accelerated selected precursor ions to a second mass analyzer is dependent on a mass-to-charge ratio of the precursor ions and is nearly independent of a velocity distribution of the selected ions.
